(19) United States
(12) Patent Application Publication
(10) Pub. No.: US 2014/0297833 A1
(43) Pub. Date: Oct. 2, 2014

(54) Systems And Methods For Self-Adaptive Distributed Systems

(71) Applicant: Alcatel Lucent, Paris (FR)

(72) Inventors: Ivan Bedini, Blanchardstown (IE); Bart Antoon Rika Theetan, Sinaai (BE); Tommaso Cucinotta, Blanchardstown (IE); Alessandra Sala, Dublin (IE)

(73) Assignee: Alcatel Lucent, Paris (FR)

(21) Appl. No.: 13/853,533

(22) Filed: Mar. 29, 2013

(51) Int. Cl. H04L 12/26

(52) U.S. Cl. CPC H04L 43/0876
USPC 709/224

(57) ABSTRACT

Systems and methods for run-time monitoring, tuning and optimization of distributed systems are provided. In various aspects, a system or method may include measuring run-time values for one or more performance metrics of the distributed system, such as, for example, task-latencies, process-throughputs, and the degree of utilization of various physical resources of the system. The system or method may further include comparing the measured run-time values with one or more target values assigned to the performance metrics, and, based on the comparison, adjusting one or more tunable run-time control variables of the distributed system, such as the number of the tasks, processes, and nodes executing in the distributed system.

### TECHNICAL FIELD

The present disclosure is directed towards computing systems. More particularly, it is directed towards systems and methods for run-time performance measurement and tuning of distributed computing systems.

### BACKGROUND

This section introduces aspects that may be helpful in facilitating a better understanding of the systems and methods disclosed herein. Accordingly, the statements of this section are to be read in this light and are not to be understood as admissions about what is or is not in the prior art.

Distributed computing generally refers to the use of multiple computing devices to solve computational problems. A typical distributed system may include multiple autonomous computing devices (also referred to herein as nodes) that communicate with each other through a communication medium such as, for example, a computer network. In distributed computing, a problem may be divided into many tasks (also called jobs), which are performed or executed in one or more interconnected computing devices. The computing devices that execute the tasks may be implemented as physical processors (e.g., processor cores) in one or more computers, or, for example, as virtual machines in a cloud.

### BRIEF SUMMARY

Systems and methods for run-time monitoring, tuning and optimization of distributed systems are provided. In one aspect, the system and method may include determining run-time values for one or more performance metrics of the distributed system; comparing at least one of the measured run-time values of the performance metrics with one or more target values corresponding to at least one of the performance metrics; and, adjusting one or more run-time control variables of the distributed system based on the comparison of the determined run-time values with the target values.

In another aspect, the system and method may also include adjusting the one or more run-time control variables by increasing or decreasing a number of instances of parallel tasks, processes, or nodes executing in the distributed system.

In one or more aspects, the system and method may also include determining the run-time values for the one or more performance metrics by determining a latency value of a task executing in the distributed system, or, determining a throughput value of a process executing in the distributed system. In addition, determining the run-time values for the one or more performance metrics may also include determining one or more utilization values corresponding to one or more resources of the distributed system, by, for example, determining a change in a size of an inter-task queue between an upstream task and a downstream task that are executing in the distributed system. Furthermore, the system and method may also include determining a latency value for the upstream task or the downstream task based on the determined change in the size of the inter-task queue.

In yet another aspect, the system and method may also include forbidding adjustment of at least one of the one or more control variables for a given period of time.

In one aspect, the system and method may also include assigning at least one of the target values corresponding to at least one of the performance metrics based on an analysis of a Directed Acyclic Graph (“DAG”).

In another aspect, the system and method may also include determining second run-time values for the one or more performance metrics of the distributed system; and, reversing at least one adjustment of a run-time control variable based on at least one of the determined second run-time values for the one or more performance metrics of the distributed system. In yet another aspect, the system and method may also include assigning a priority corresponding to at least one of the performance metrics; and, reversing an adjustment of at least one of the run-time control variables based on the at least one assigned priority.

In another aspect, the system and method may also include adjusting at least one of the run-time control variables more frequently than at least another one of the run-time control variables.

In one aspect, the system and method may further include comparing the measured run-time values of the performance metrics with one or more target values assigned to the performance metrics by determining that at least one of the measured run-time values is outside a target feasibility region. In various aspects, the system and method may also include computing a normalized distance between the at least one of the measured run-time values and the target feasibility region.

### BRIEF DESCRIPTION OF THE DRAWINGS

FIG. 1 illustrates a simplified example of a task-centric distributed system.

FIG. 2 illustrates an example of a run-time tuned distributed system in accordance various aspects of the disclosure.

FIG. 3 illustrates an example of a process flow diagram for tuning a distributed system in accordance with various aspects of the disclosure.

FIG. 4 illustrates an example of an apparatus for implementing various aspects of the disclosure.

### DETAILED DESCRIPTION

As used herein, the term, “or” refers to a non-exclusive or, unless otherwise indicated (e.g., “or else” or “or in the alternative”). Furthermore, as used herein, words used to describe a relationship between elements should be broadly construed to include a direct relationship or the presence of intervening elements unless otherwise indicated. For example, when an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Similarly, words such as “between”, “adjacent”, and the like should be interpreted in a like fashion.

The present disclosure presents self-adaptive systems and methods for monitoring, tuning, and optimizing the performance of distributed systems. In various aspects, the systems and methods may include run-time modification of one or more tunable parameters of a distributed system in order to conform one or more measured performance metrics of the distributed system to predetermined target performance metrics without manual intervention, stoppage, or redeployment of the distributed system.

The figures and the following description illustrate embodiments in accordance with various aspects of the disclosure. It will thus be appreciated that those skilled in the art will be able to devise various arrangements that, although not explicitly described or shown herein, embody the principles of the disclosure. Furthermore, any examples described herein are intended to aid in understanding the principles of the disclosure, and are to be construed as being without limitation to such specifically recited examples and conditions. As a result, the present disclosure is not limited to the specific embodiments or examples described below, but by the claims and their equivalents.

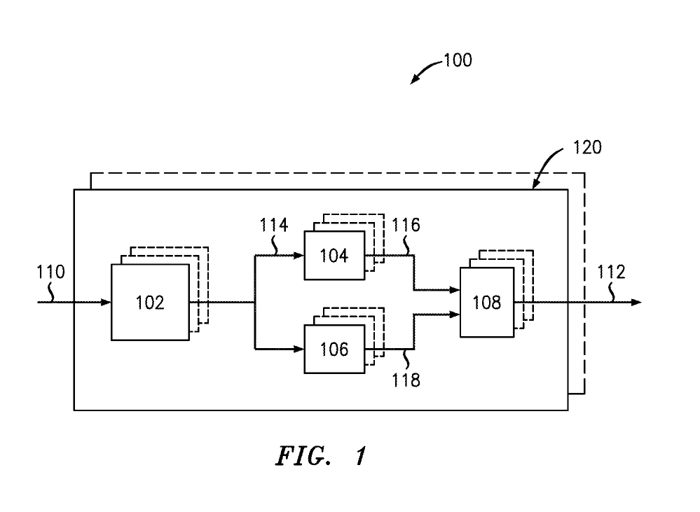

FIG. 1 illustrates a simplified example of a task-centric distributed system 100 in accordance with various aspects of the disclosure. As shown in FIG. 1, system 100 includes interdependent tasks 102, 104, 106, and 108, which collectively process an input data stream 110 to produce an output data stream 112. A data stream may be understood as a flow or stream of data that may be processed in a distributed system such as the distributed system 100 between data sources, computing devices and data stores. The data stream may be a continuous stream of data (e.g., an audio or video data stream), or, alternative, may be any data periodically or intermittently transmitted from a data source to a data store (e.g., a web-page, a database record, etc.). In this regard, the data source may be any source of electronic data, such as, without limitation, a server device, a user device, or a system of user or server devices, one or more sensors, input/output devices, a communication bus, a network, a database, a file, or any other source capable of transmitting or providing data. Similarly, the data store may be any intended destination of data, which, without limitation, may be any type of destination such as a server device, a user device or a system of user or server devices, one or more sensors, input/output devices, a communication bus, a network, a database, a file, or any other destination capable of receiving or storing electronic data.

The workflow to be carried out by the various tasks of the distributed system such as the distributed system 100 upon the data streams, and the inter-dependencies of the tasks, may be specified in a Directed Acyclic Graph (DAG). The DAG may specify the order of computations to be carried out on one or more input data streams by various tasks in an application, so as to produce one or more output data streams. The output data streams may, in turn, be input data streams for other tasks which may produce additional output data streams. Since the DAG topology represents the sequential relationships among the various tasks in terms of the input and output data streams, a distributed system may be designed to perform computations concurrently or in parallel, exploiting the distributed resources of the underlying physical or virtualized hardware. Thus, it is contemplated herein that in one aspect the interdependence of the tasks 102-108 (e.g., order of execution) and the input data and output data processed by each of the tasks, may be topologically specified in a DAG.

Furthermore, it will be understood that while the present disclosure is not in any way limited to distributed systems realized or designed using a DAG, there are certain advantages to using a DAG. For example, applications or programs developed for distributed computing may advantageously leverage general-purpose development frameworks that utilize the DAG for automatically managing the deployment and synchronization of various tasks executed by the computing devices in the distributed system. Furthermore, an application developer may focus on the functionality needed in the application and on the specification of the dependencies among the tasks, while the task synchronization and deployment are automatically handled within the framework. For example, the framework may automatically select the most efficient inter-task communication mechanisms depending upon whether the tasks are deployed as threads in a same process or in different processes, or whether the tasks are deployed on the same node (physical or virtual) or different nodes of the distributed system.

Returning to FIG. 1, each of the tasks 102-108 may execute upon input data to produce output data. As shown in FIG. 1, for example, task 102 may receive input data stream 110 as input data and process the input data to produce output data 114. Output data 114 produced by task 102 may be received as input data by tasks 104, 106, which, in turn may process the input data to produce output data 116, 118, respectively. Output data 116, 118 produced by tasks 104, 106 may then be received as input data by task 108, which may process the input data to produce a final output data stream 112 in accordance with the topology specified in the DAG.

The distributed system illustrated in FIG. 1 may be configured in various ways. For example, each of the tasks 102-108 may be executed as a distinct thread in a multi-threaded process 120. In turn, process 120 may itself be executed in one or more computing devices or nodes. In other configurations, some or all of the tasks 102-108 may be executed in separate processes 120, which, in turn, may be executed in different nodes that are communicatively interconnected with each other.

In various aspects, the degree of parallelization of various components such as the tasks, processes, and nodes in a distributed system are configured as a set of tunable run-time parameters (also referred to herein as control variables) of the distributed system. For example, any or all of the number of concurrent instances of each of the tasks 102-108 executing per process 120 in the distributed system 100, the number of concurrent instances of processes 120 executing per node in the distributed system, and the number of nodes executing in the distributed system can be configured as tunable parameters or control variables that may be adjusted during run-time of the distributed system. Tunable control variables may also be configured for various physical or virtual resources of the distributed system, such as memory allocated to various components, inter-task or inter-process messaging queues, network bandwidth between interconnected nodes, and the like. In various aspects, such control variables are selectively and iteratively adjusted during run-time so as to tune or optimize the performance of the distributed system to conform to predetermined target values for one or more measured performance metrics.

In various aspects, the performance metrics of a distributed system include, for example, latency metrics, throughput metrics, or utilization metrics. Latency metrics may be understood as a measure of the time it takes a data item to traverse through a set of computations performed by one or more components of the distributed system. Thus, in various aspects, latencies for various tasks (or combination of tasks) are measured from the time a data item is available as input data to the time an output data item is produced by the task or tasks. In the simplified distributed system 100 of FIG. 1, for example, a collective latency may be measured for tasks 102-108 as the time it takes to process one or more data items from the input data stream 110 to produce one or more output data items in output data stream 112. In general, latencies for any combination of one or more tasks, processes, or nodes of the distributed system are measured as the period of time it takes to process an available input data item and produce a corresponding output data item by the respective tasks, processes, or nodes.

In various aspects, throughput metrics are measured as a rate at which input data items or output data items are processed by one or more tasks, processes, or nodes of the distributed system in a given period of time. For example, in one aspect throughput is measured as the rate at which a number of tuples (e.g., bytes or words) are transmitted or received at various points in the distributed system. In the distributed system 100 of FIG. 1, a collective throughput for tasks 102-108 may thus be measured as the rate at which a number of bytes are received or output by the process 120. Similarly, throughput metrics for any combination of one or more tasks, processes, or nodes of the distributed system may be measured as the rate at which one or more data items are processed over a period of time.

Utilization metrics, as described herein, generally refer to measurements associated with the availability or use of one or more physical or virtual resources of the distributed system. The utilization metrics may measure, for example, the degree of utilization of the nodes (physical or virtual) in the distributed system, the degree of utilization of local or shared memory in the distributed system, the number or size of inter-task or inter-process queues in the distributed system, the number and capacity of one or more storage elements in the distributed system (e.g., databases, hard-drives), and the characteristics of the networking elements of the distributed system (e.g., network bandwidth).

The degree of use of various resources in the distributed system may also indicate financial costs attributable to the distributed system. For example, increasing the number of available tasks, processes, nodes, memory, or network bandwidth of the distributed system may also represent an increase in the overall financial cost of the distributed system by a given amounts. In this regard, the utilization metrics may also be understood to represent current or predicted financial costs of the distributed system based on the availability or utilization of the resources of the distributed system.

One or more predetermined target values may be assigned to the various performance metrics deemed relevant to the distributed system. For example, target values for maximum latency may be assigned to one or more tasks (or processes) or combinations of tasks (or processes) in the distributed system. Similarly, target values for minimum throughput may also be assigned to one or more tasks or processes (or combination of tasks or processes) in the distributed system. In addition, target values may also be assigned, as a representation of cost, for utilization metrics associated with various resources of the distributed system such as the number of nodes, memory, network bandwidth, etc. The target values may be specified as a single value (as in a minimum or maximum value, for example) or as a range of values (e.g., a minimum value to a maximum value).

The target values for the performance metrics may be used for tuning or optimization of one or more performance metrics of interest of the distributed system. Such tuning or the optimization may include minimization or maximization of one or more measured performance metrics of the distributed system. For example, target values may be used for minimizing, to the extent possible, a measured latency associated with the distributed system for optimization, while keeping one or more other measured performance metrics such as throughput within specified values or bounds. Once target values are selected and assigned with respect to one or more performance metrics or combinations thereof, one or more control variables of the distributed system may be selected and adjusted to meet or exceed, to the extent possible, the assigned performance criteria for the distributed system.

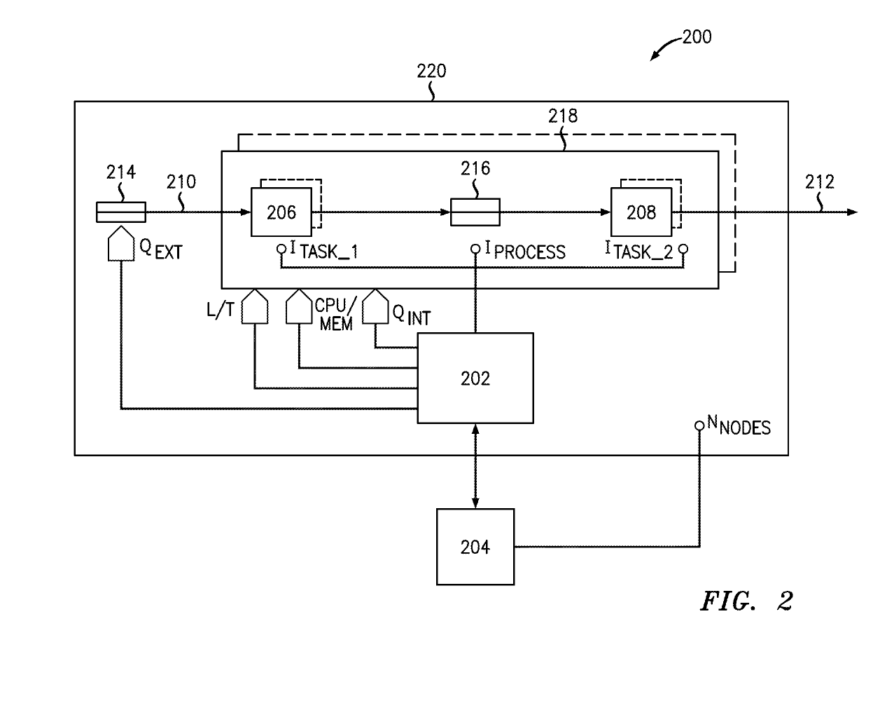

FIG. 2 illustrates a simplified embodiment of a run-time tuned distributed system 200 in which controllers 202, 204 are communicatively interconnected to each other and configured to adjust the performance of the distributed system 200 in accordance with various aspects of the disclosure. As in distributed system 100, distributed system 200 includes interdependent tasks, namely, tasks 206 and 208 which collectively process an input data stream 210 to produce an output data stream 212. The interdependence of the tasks 206 and 208 (e.g., order of execution) and the input data and output data for each of the tasks, may be topologically specified in a DAG.

Each of the tasks 206, 208 execute upon input data to produce output data. As shown in FIG. 2, for example, task 206 receives input data stream 210 as input data from an external queue 214 and processes the input data to produce output data which is stored in internal queue 216. The output data produced by task 206 and stored in internal queue 216 is received as input data by task 208, which, in turn may process the input data to produce the final output data stream 212 as may be specified in the DAG topology.

As with distributed system 100 illustrated in FIG. 1, distributed system 200 may be configured in various ways. As shown in FIG. 2, for example, each of the tasks 206, 208 may execute as a distinct thread in a multi-threaded process 218 which is, in turn, itself executed in a computing device or node 220. In other embodiments, tasks 206, 208 may each execute in separate processes 218 that are executed in different nodes 220 which are communicatively interconnected to each other.

While only a few tasks, processes, and nodes are illustrated in FIG. 2, it will be understood that a typical implementation of distributed system 200 may include any number of nodes 220 that are interconnected to each other and to the controllers 202, 204 via, for example a network. Furthermore, each such interconnected node 220 may execute a number of parallel instances of processes 218, each of which may, in turn, execute a number of parallel instances of tasks 206, 208. The number of nodes, processes, and tasks of the distributed system 200 may be limited only by the physical resources (e.g., processors, memory, and network bandwidth) or financial costs attributable to the system.

Controllers 202 and 204 may be collectively configured to adjust one or more control variables at run-time to tune/optimize the performance of the distributed system 200. The control variables that are adjusted may be used to increase or decrease the number of tasks, processes, or nodes that are executing concurrently in the distributed system. In one aspect, controller 202 may be a local-controller, while controller 204 may be a centralized or global controller. Local controller 202 may be configured to increase or decrease the number of instances of process 218 (I_{PROCESS} in FIG. 2) that are executed in parallel in the node 220 of the distributed system. Local controller 202 may also be further configured to increase or decrease the number of parallel instances of tasks 206 and task 208 (I_{TASK}_{_{—}}₁, I_{TASK}_{_{—}}₂ in FIG. 2) that are respectively executed in the process 218 of node 220. Thus, local controller 202 may be understood as a node-level controller configured to adjust the number of parallel processes executing in a particular node of the distributed system and also as a process-level controller configured to adjust the number of instances of the tasks executing in parallel in the parallel processes executing in the particular node of the distributed system. Global controller 204, as a system-wide controller, may be configured to increase or decrease the overall number of interconnected nodes 220 (N_{NODES} in FIG. 2) that are concurrently executing in distributed system 200. Furthermore, global controller 204 may be communicatively connected to one or more node-level controllers 202 that are distributed in different nodes 220 of the distributed system 200.

Controllers 202, 204 may be implemented in various ways. For example, in one embodiment the local controller 202 may be implemented as a software application that is distributed and executed in each of the nodes 220 of the distributed system 200, whereas global controller 202 may be implemented as a separate software application executing in another node of the distributed system. In another embodiment, controllers 202, 204 may be combined into a single controller that is either communicatively connected to, or itself distributed within, one or more nodes 220 of the distributed system 200. In yet another embodiment, separate node-level controller(s), process-level controller(s) and system-wide controller(s) may be distributed within, or communicatively connected to, one or more nodes of the distributed system 200.

Controllers 202, 204 (hereinafter collectively referenced as “the controller”), may determine one or more measured performance metrics to actuate the increase or decrease in the number of instances (or replicas) of the tasks, processes, or nodes executing concurrently in the distributed system. As shown in the example of FIG. 2, the measured performance metrics may include one or more latency and throughput measurements L/T for each of the task 206, task 208, and the process 218 executing in the distributed system. In addition, the measured performance metrics may also include one or more utilization measurements, such as a utilization measurement Qₑₓₜ indicating the utilization of the external queue 214, a utilization measurement Qᵢₙₜ indicating the utilization of the internal queue 216 within process 218, and utilization measurements CPU/Mem indicating the utilization of the processing cycles or memory used in the one or more nodes 220 of the distributed system 200.

The controller may adjust the tunable control variables (e.g., number of the concurrently executing tasks, processes, and nodes) in the distributed system 200 to tune/optimize the measured performance metrics of interest to one or more target values. The target values assigned to the performance metrics of interest may be determined in several ways. For example, in one aspect the target values may be automatically determined by the controller (e.g., global controller 204) by analyzing the DAG topology describing the operation of the distributed system. In this case, the controller may be configured to identify performance metrics of interest based on the interdependencies of one or more tasks (or processes) and the expected input and output data, and assign target values based on such analysis. In another aspect, the target values may be manually provided for the performance metrics of interest (e.g., in a configuration file). In this case, the controller may assign the target values (e.g., by reading the configuration file) during run-time and adjust the performance of the distributed system without requiring any stoppage or redeployment of any task, process, or nodes in distributed system. In yet another aspect, the target values initially determined for the performance metrics of interest (whether automatically or manually), may be dynamically adjusted based on actual measurement of the performance metrics during run-time operation of the distributed system without any manual intervention.

In addition to the foregoing, one or more of the performance metrics of interest may also be prioritized relative to other performance metrics of interest. For example, in the distributed system 200, the controller may strive to adjust the control variables to maintain one or more performance metrics having a higher assigned priority (e.g., throughput of process 220) within specified bounds, even if this means that one or more other performance metrics (e.g., latencies for one or more tasks) having a lower priority are adversely affected and, in some cases fall outside of specified bounds. As another example, the controller may first aim to keep the overall deployment cost (e.g., due to the number of deployed physical processors or virtual machines) within given bounds, while also trying to keep latency or throughput as close to assigned target values as possible. The relative priorities may be determined in several ways. For example, the relative priorities may be assigned by the controller based on interdependencies indicated in the DAG (e.g., bottlenecks may be identified and assigned higher priorities) or in view of the overall cost objectives or the design objectives of the distributed system.

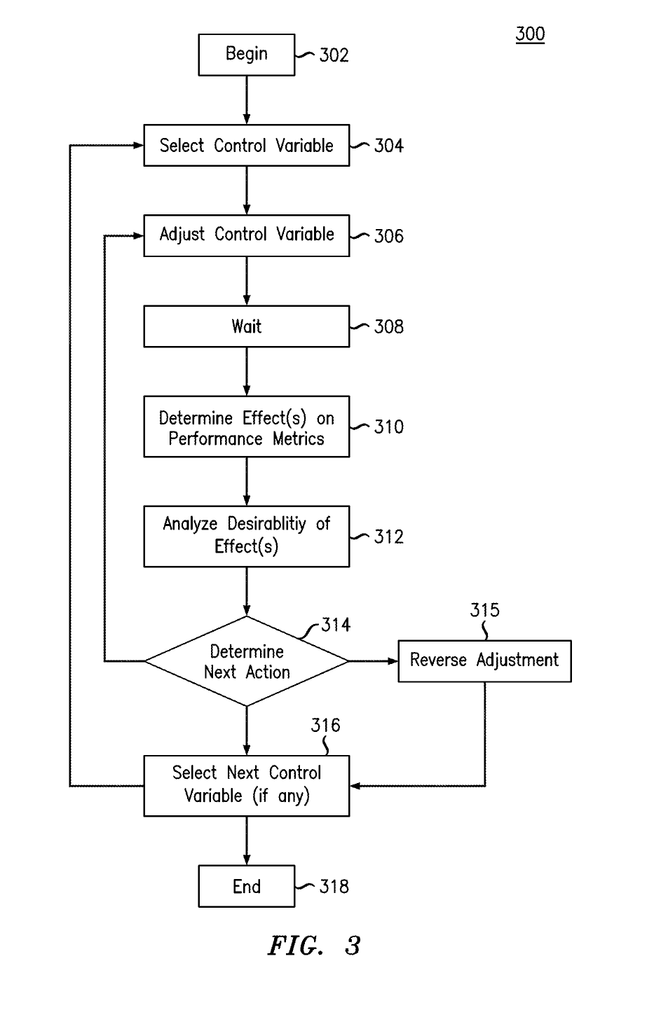

FIG. 3 illustrates an example of a process 300 for run-time tuning of the performance of a distributed system in accordance with various aspects of the disclosure. Process 300 may be implemented, for example, by controllers 202, 204 in the distributed system 200 shown in FIG. 2.

The process may begin at step 302, at which time one or more performance metrics may be measured during the run-time operation of the distributed system. In the distributed system 200 of FIG. 2, for example, the controller (e.g., local controller 202) may determine that the performance metrics of interest for the distributed system 200 include latency values for each of the tasks 206, 208 and a throughput value for process 218 executing in a particular node 220 of the distributed system. The latency value for each of the tasks 206, 208, may be measured as the time it takes each respective task to process an input data item to produce an output data item. The throughput value of process 218 may be measured as the rate at which a number of bytes are output (or input) by process 218 over a period of time.

In addition, the controller may also determine that the performance metrics of interest include utilization metrics for various resources of the distributed system 200 such as the external queue 214, the internal queue 216, and the CPU and memory utilization of node 220. The controller may use the utilization measurements as a representation of the costs (e.g., total cost) associated with one or more components of the distributed system 200. For example, the controller may represent costs at the task, process, and node levels based on the utilization of one or more resources of the distributed system.

In one aspect, the controller may normalize the measured values of the performance metrics to obtain values that are comparable in type or order of magnitude. For example, the measured utilization metrics for the various resources may be expressed in terms of monetary costs that may be aggregated to determine an overall cost for the distributed system. Furthermore, a vector may be computed for the normalized metrics, where the vector may constitute a current overall state of the distributed system at a given point in time. For example, a vector of the various measured values of the utilization metrics may be computed to represent an overall cost of the distributed system 200 at the time of the measurement.

At step 304, the process may include selecting a control variable of the distributed system for adjustment. The control variable may be selected based on a comparison of one or more of the measured performance metrics of interest with one or more assigned target values. As described previously, the controller may assign target latency values for each of the tasks 206, 208 in FIG. 2. Similarly, the controller may also assign a target throughput value to the process 220. Finally, the controller may assign utilization values to the resources of the distributed system 200, such as the internal queue Qᵢₙₜ, the external queue Qₑₓₜ, and the CPU cycles and memory utilization of one or more the node(s) 220 of the distributed system.

As with the measured values, the controller may normalize the assigned target values for comparison with the normalized measured values. The target values may be specified as particular values, such as maximum values for latency or overall cost, and a minimum value for throughput. Alternatively, some or all target values may also be specified as a range (also referred to herein as a feasibility region), such as from a minimum value to a maximum value, or centered round an optimum desired value (e.g., optimum desired value±a delta value).

The controller may select a control variable to adjust based on a determination that measured values for one or more performance metrics do not conform to desired target values. For example, the controller may determine that the latency value for task 206 that was measured in step 302 is not within a target feasibility region for that task. The controller may also compute the distance between the measured latency value and the assigned target value. Where the assigned target value is a range, for example, the controller may determine the distance by which the measured value is outside the range. The distance may be expressed as a normalized distance in a space of normalized metrics of interest, such as the distance between a current measured value of a performance metric and the closest point of the feasibility region for that metric. The normalized distance may be considered to be null when the measured value is within the feasibility region, or strictly positive when the measure current value is outside the feasibility region in either direction.

Thus, the controller may not only determine that the latency value for task 206 is outside the feasibility region, but may also compute the distance by which the measured value lies outside the feasibility region. The controller may then select the number of instances of task 206 (I_{TASK}_{_{—}}₁) as the control variable to be adjusted, in order to bring the measured latency for task 206 within the target feasibility region (e.g., reduce the distance to null) or as close as possible.

At step 306, the process may include adjusting the selected control variable in order to tune the run-time performance of the distributed system to meet the desired target value. For example, the controller may actuate an increase in the number of parallel instances of task 206 that are executing in the process 218 (e.g., by adding another concurrent instance of task 206 for execution in process 218) in order to improve the overall latency for the task.

At step 308, the process may include waiting for a predetermined period of time T for the actuated control variable to have an effect on one or more measured performance metrics in the distributed system. For example, the controller may wait a suitable period of time (e.g., thirty seconds, five minutes, or one hour) after actuating an increase in the number of instances of task 206.

At step 310, the process may include determining the effect of the adjustment of the control variable on the performance of the distributed system and whether the effect is an improvement or not. In various aspects, such determination may include re-measuring one or more of the performance metrics deemed relevant to the distributed system. For example, the controller may measure, in step 310, all of the performance metrics that were measured initially in step 302, including the latency values for tasks 206, 208, the throughput value for process 218, and each of the utilization measurements described above. Alternatively, the controller may measure, in step 310, only particular performance metrics that were targeted by the actuated control variable (i.e., the latency of task 206). While either approach may be viable for determining an effect of an adjustment on a targeted performance metric, measuring all of the performance metrics of interest may be advantageous in embodiments in which one or more performance metrics have been prioritized. This is because the controller may not only determine the effect (e.g., magnitude) of adjusting a control variable on a particular performance metric(s) targeted by the adjustment, but may also determine any effect, adverse or favorable, the adjustment may have on other performance metrics, and particularly those that may have been assigned a higher priority. Furthermore, in one aspect, the controller may also store and analyze the determined effect on other performance metrics, and use such analysis to better estimate or predict effects (e.g., magnitudes) that may be expected from a future adjustment of one of the control variables.

In step 312, the process may include analyzing the performance metrics measured in step 310 to determine whether the adjustment of the selected control variable resulted in a desired improvement in the performance of the distributed system or not. Such determination may be based on one or more considerations, which are described below.

In one aspect, for example, step 312 may include calculating one or more post-adjustment distances between the measured performance metrics from step 310 and respective target values assigned to the performance metrics. The computed post-adjustment distances may be compared with pre-adjustment distances computed from the initial values of the performance metrics that were measured in step 302. A determination may then be made as to whether the adjustment of the selected control variable resulted in an improvement in the performance of the distributed system or not based on whether the post-adjustment distances are less than, greater than, or the same as the pre-adjustment distances.

For example, the controller may determine that adjusting the distributed system 200 by adding another instance of task 206 (step 306) provided a desired improvement in the measured latency of the task. The controller may begin by determining whether the post-adjustment latency measurement for task 206 is now in the feasibility region (e.g., post-adjustment distance is null or zero). If the post-adjustment latency measurement is within the feasibility region, the controller may determine that the measured latency value now meets the assigned target value for task 206 and that the adjustment provided the desired performance improvement. If the post-adjustment latency measurement is outside the feasibility region, the controller may still determine that the adjustment provided an improvement if the post-adjustment distance is less than the pre-adjustment distance by at least a pre-determined threshold K. Alternatively, the controller may consider any reduction in the post-adjustment distance over the pre-adjustment distance as a desired improvement, even if the post-adjustment latency did not improve enough to meet assigned target values.

The controller may also determine that adjusting the distributed system 200 by adding another instance of task 206 did not provide a desired improvement. For example, the controller may determine that the post-adjustment distance is greater than the pre-adjustment distance and conclude that not only did the adjustment did not have the desired improvement, but also that the adjustment resulted in an unintended or adverse effect. Such determination may occur, for example, where the post-adjustment latency is found to be greater than the pre-adjustment latency initially measured in step 302. Furthermore, the controller may also conclude that the adjustment did not have the desired improvement where the post-adjustment distance is substantially the same in comparison to the pre-adjustment distance, or where the post-adjustment distance does not improve by at least a pre-determined threshold K. This embodiment may be advantageous because adding another instance of task 206 to the distributed system 200 is likely to increase the overall cost of the distributed system. Where there is little or not enough of an improvement by the adjustment, the additional cost may not be justifiable in view of the change in the performance of the distributed system.

In one aspect, the controller may also determine that the adjustment in step 306 did not provide a desired improvement if the adjustment adversely effects one or more other performance metrics that are of a higher priority. For example, even if the post-adjustment latency of task 206 improves by at least a threshold K by adding another concurrent instance of task 206, it may be the case that there is, as a result, an undesirable effect on the post-adjustment throughput of process 218 which may have a higher assigned priority. Furthermore, in some cases the undesirable effect on other performance metrics having a higher priority may be severe enough to drive the post-adjustment measured values of the higher priority performance metrics outside their associated feasibility range. In such cases, the controller may determine that the adjustment did not have the desired improvement in the operation of the distributed system.

In step 314, the process may include taking additional actions based on the determination in step 312 as to whether the adjustment was desirable or not. For example, if the controller determines that the adjustment of adding another instance of task 206 to process 218 was desirable and that the post-adjustment latency measurement meets the assigned target values (e.g., is in the feasibility range or within a delta of an optimal value), then the controller may determine that no further action is needed for adjusting the latency of task 206 and thus the process may proceed from step 314 to step 316 to select another one of the control variables for adjustment. Alternatively, if the controller determines that the adjustment of adding another instance of task 206 to process 218 was desirable but did not meet assigned target values, then the process may proceed from step 314 back to step 306 to additionally adjust the same selected control variable (e.g., add yet another instance of task 206) and reiterate the steps described above.

If determined determination is made that the adjustment was not desirable, the process may proceed from step 314 to step 315. Step 315 may include reversing the adjustment of step 310 in order to bring the performance of the distributed system back to a state prior to the adjustment. For example, the controller may remove the additional instance of task 206 that was added to the distributed system 200. Step 315 may also include waiting for a period of time (e.g., time T as in step 308) for the reversal to take effect in the system. After waiting a suitable period of time, the process may proceed from step 315 to step 316 to select another one of the performance metrics for adjustment.

In step 316, the process may include determining if there are any remaining control variables that may be selected for adjustment. For example, the controller may determine that the control variables that were not adjusted in the steps above and are thus remaining for adjustment include the number of instances of the task 208, the process 218, and node 220. In addition, step 316 may also include forbidding the adjustment of any recently adjusted control variable(s) for a period of time. For example, having adjusted the number of concurrent instances of task 206 to improve the latency metrics for task 206 as described above, the controller may forbid another adjustment to the number of concurrent instances of task 206 for at least a period of time. If a determination is made in step 316 that there are remaining control variables that are due for adjustment, the process may return to step 304. Alternatively, if a determination is made that adjustment of all control variables is forbidden, the process may end at step 318.

The process 300 described in FIG. 3 may be periodically activated in order to continually tune/optimize the performance of the distributed system based on real-time conditions. For example, the controller may periodically execute the process once or several times a day (e.g., every four or eight hours). The controller may also activate the process more often (e.g., every half hour, hour, or even continuously), when more frequent monitoring, tuning, and adjustment of the distributed system may be desired at certain times of the day.

In one aspect, the process may be activated to adjust particular control variables more frequently than other control variables. For example, local controller 202 may activate process 300 more frequently (e.g., every hour) to adjust the number of instances of the tasks (e.g., tasks 206, 208) executing parallel in the process 218 and less frequently (e.g., every four hours) to adjust the number of instances of parallel processes 218 executing in the node 220. Furthermore, the global-controller 204, as the centralized system-wide controller, may activate the process 300 less frequently than the local controller 202 (e.g., once a day) to adjust the number of overall nodes 220 in the distributed system 200.

The systems and methods disclosed herein provide a number of advantages. It is contemplated that the various embodiments disclosed herein may complement and enhance existing distributed parallel systems for self-adaptively tuning or enhancing the performance of such distributed systems without requiring stoppage, redeployment, or implementation of a new system. Such embodiments may also be implemented by integrating with or modifying existing software.

For example, the controller may monitor the performance metrics (e.g., L/T, CPU/MEM, Qᵢₙₜ, Qₑₓₜ) and adjust the control variables, by calling one or more application programming interfaces (APIs) provided by, for example, device drivers, queue managers, operating system, distributed system framework, processes, or tasks in one or more nodes of the distributed system. By way of specific example, the controller may obtain queue utilization metrics (Qᵢₙₜ, Qₑₓₜ) by calling one or more interfaces provided by a queue manager or a queue device driver. As another example, the controller may also obtain CPU/MEM utilization metrics by calling one or more interfaces provided by the operating system managing the resources of one or more of the nodes 220 of the distributed system. Similarly, the controller may call one or more interfaces provided by the operating system, distributed framework platform, process, or task to increase or decrease the number of instances of processes, tasks, and nodes of the distributed system without requiring any coding changes to the existing tasks and processes of the distributed system.

The latency and throughput metrics that are described herein may be obtained in various ways. As noted above, the controller may call one or more interfaces provided by, for example, the operating system, process, or tasks to determine the latency and throughput metrics L/T for one or more parallel instances of the tasks or processes executing in node 220. Where it is not possible to obtain latency or throughput metrics directly, such metrics may also be computed or inferred indirectly via monitoring changes in the utilization metrics for one or more resources of the distributed system. For example, bottleneck tasks may be identified by monitoring the size (e.g., rate of growth) of one or more queues of the distributed system. In a case where even the queue utilization information is not directly available, the controller may compute the difference between the number of tuples (e.g., bytes) emitted by two consecutive tasks to derive the size of the queue interconnecting the two tasks over time.

In either case, if the controller observes that the size of a queue is growing (e.g., has exceeded a maximum value of an assigned feasibility region), then it may determine that the downstream task is too slow, and may thus allocate more instances of that task periodically as described above until the queue size returns below the maximum assigned value. On the other hand, if the controller observes that the queue size for a queue is decreasing (e.g., decreased below a minimum value of the assigned feasibility range), then the controller may determine that the upstream task needs more resources and allocate more instances of that task periodically as described above until the queue increases above the minimum assigned value. Alternatively, the controller may also lower the parallelism of the downstream task to save resources and hence reduce financial costs attributable to the distributed system. Such “down-sizing” of the parallelism of the distributed system may be advantageous to reduce cost while encountering a temporarily lower rate of incoming data streams.

The systems and methods disclosed herein may not only be applied to tune the performance of a distributed system but may also be applied to optimize the performance of the distributed system. For instance, the target values assigned to the performance metrics may not only define a feasibility range, but may additionally specify an optimal desired value within the feasibility region. In this case, the controller may periodically execute or iterate process 300 to adjust one or more control variables for initially bringing the measured value of the performance metrics within the specified feasibility region, and, once this is accomplished, may continue to periodically execute or iterate process 300 to bring the measured value as close as possible to the optimal desired value within the feasibility range.

It is also contemplated that the adjustments made to one control variable may be carried forward when adjusting another control variable for maintaining a desired balance in the performance of the distributed system. For example, the controller in the distributed system 200 may add one instance of task 206 and two instances of task 208 to bring the measured latencies of the tasks within the respectively assigned feasibility regions. The controller may then maintain the balance of the ratio of the number of instances of each task (two total instances of task 206 and three total instances of task 208), when adding a new instance of the process 218 in order to increase and bring the overall throughput of the process within its feasibility region.

As noted previously, the performance metrics of interest to the distributed system may be prioritized. Such prioritization may be desired in view of the potential trade-off between the latency, throughput, and utilization metrics (e.g., as a measure of the cost of the distributed system). For example, adjusting the number of parallel instances of a task may improve latency but may adversely affect throughput of the process and increase (even if marginally) the cost of the distributed system. Furthermore, adjusting the number of processes of the distributed system may improve throughput, but may negatively impact latency and may be expected to have a greater effect on the cost of the distributed system. Finally, increasing the number of nodes of the distributed system may provide better overall performance (in terms of latency and throughput) but result in the greatest adverse effect on the financial costs of the distributed system in view of the provisioning and utilization of additional resources.

Therefore, in one aspect, it may be desirable to provide a set of prioritized rules for the target values of one or more of the performance metrics in view of the tradeoff described above. A representative set may include, for example, prioritized rules for the throughput, latency, queue size, overall system utilization, and the number of nodes in the system (as a proxy measure of the overall financial cost of the system). By way of an example for each of the above, a rule may specify throughput for one or more processes as greater than a target arrival rate±a throughput delta value (delta throughput δt). Another rule may specify latency for one or more tasks as, for example, less than or equal to a target latency plus a latency delta value (delta latency δl). As latency and throughput measurements may be derived from utilization metrics of one or more queues, a rule may specify a target size of an external (or internal) queue as lower then a certain threshold (sigma external queue σq). The last two rules may assign a target value for the average system utilization between two thresholds (upper and lower utilization thresholds, ρmax ρmin), and the overall system cost in terms cluster size (maximum number of allocable nodes (N)). Appropriately prioritized based on the desired tradeoffs, the set of rules described above may be helpful in realizing at least some improvement in the performance of the distributed system while reducing the possibility of unintended effects.

The priority of the rules may influence the selection and adjustments of the control variables by the controller. For example, if the distributed system reaches the maximum allowable number of nodes designated by a rule having the highest priority, the controller may forego allocating additional nodes even if it means not meeting assigned target values for overall throughput for one or more processes. Of course, while prioritized rules may be advantageous in some cases, it will be understood that the systems and methods disclosed herein are not limited to any particular set of prioritized rules, and various aspects may be implemented that include fewer or greater number of prioritized rules or even no prioritized rules. Yet further, in one or more aspects the controller may also be configured (e.g., via a configuration file), to dynamically add, remove, or update one or more prioritized rules without requiring any stoppage or redeployment of any component of the distributed system.

The local controller and the global controller disclosed above may communicate to adjust and maintain the performance of the distributed system. If the local controller(s) in the existing node(s) reach maximum/minimum performance limits from the resources available within such nodes, then the global controller may increase/decrease the overall number of nodes allocated to the cluster to further improve the performance of the distributed system. For example, the local controllers may periodically adjust the number of instances of the tasks and processes executing in the existing nodes, and if such adjustments do not result in an expected improvement or result in a degradation of the performance (due to limits of the physical resources on the nodes), the local controller may reverse the adjustments to return the distributed system to a stable state and inform the global controller. At this point, the global controller may then add additional nodes to the distributed system as warranted. On the other hand, if the available resources on existing nodes are greater than what is needed to maintain the desired performance, the global controller may also reduce the number of nodes, processes, or tasks executing in the distributed system.

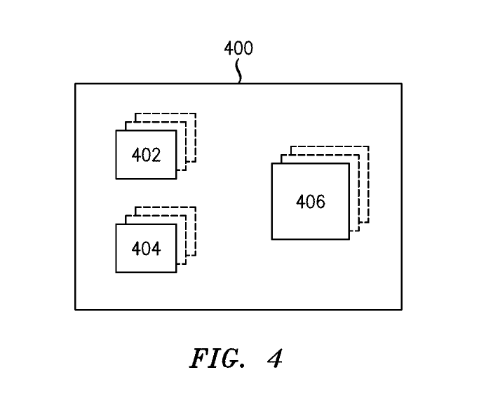

FIG. 4 depicts a high-level block diagram of a computing apparatus 400 suitable for use in performing the functions described herein. As depicted in FIG. 4, apparatus 400 may comprise one or more processor elements 402 (e.g., one or more CPU cores), a memory 404, e.g., random access memory (RAM) or read only memory (ROM), and various input/output devices 406 (e.g., network adapters, storage devices, including but not limited to, tape drives, hard disk drives or compact disk drives, one or more displays, data ports, and various user interface devices (such as a keyboard, a keypad, or a mouse)) that are communicatively connected via, for example, an internal bus. In one embodiment, each of the one or more of the processor elements 402 may be implemented as a computing device or node of the distributed system in accordance with various aspects of the disclosure. Alternatively or in addition, one or more of the computing nodes of the distributed system may also be implemented as one or more apparatuses 400 that are interconnected with each other via a network.

The memory 404 may include data and instructions which, upon execution, may configure one or more of the processors 402 as the local controller or the global controller in accordance with various aspects of the disclosure. The memory 404 may also include the processes or tasks that are executed in parallel by one or more processors 402 in apparatus 400. In addition, apparatus 400 may also include an operating system, queue managers, device drivers, or one or more network protocols that are stored in memory 404 and executed by one or more processors 402.

It will be appreciated that the systems and methods disclosed herein may be generally implemented in software, hardware, or in a combination of software and hardware. For example, in one embodiment the local or the global controller may be implemented using one or more application specific integrated circuits (ASICs), field programmable gate arrays (FPGAs), general purpose computers, or any other combination of hardware or software.

Although aspects herein have been described with reference to particular embodiments, it is to be understood that these embodiments are merely illustrative of the principles and applications of the present disclosure. It is therefore to be understood that numerous modifications can be made to the illustrative embodiments and that other arrangements can be devised without departing from the spirit and scope of the disclosure.

1. A method for adjustment of a distributed system, the method comprising:
determining run-time values for one or more performance metrics of the distributed system;
comparing at least one of the measured run-time values of the performance metrics with one or more target values corresponding to at least one of the performance metrics; and,
adjusting, via a controller, one or more run-time control variables of the distributed system based on the comparison of the determined run-time values with the target values.

2. The method of claim 1, wherein adjusting the one or more run-time control variables further comprises:
increasing or decreasing a number of instances of parallel tasks, processes, or nodes executing in the distributed system.

3. The method of claim 1, wherein determining the run-time values for the one or more performance metrics further comprises:
determining a latency value of a task executing in the distributed system.

4. The method of claim 1, wherein determining the run-time values for the one or more performance metrics further comprises:
determining a throughput value of a process executing in the distributed system.

5. The method of claim 1, wherein determining the run-time values for the one or more performance metrics further comprises:
determining one or more utilization values corresponding to one or more resources of the distributed system.

6. The method of claim 5, wherein determining the one or more utilization values further comprises:
determining a change in a size of an inter-task queue between an upstream task and a downstream task executing in the distributed system.

7. The method of claim 6, further comprising:
determining a latency value for the upstream task or the downstream task based on the determined change in the size of the inter-task queue.

8. The method of claim 1, further comprising:
forbidding adjustment of at least one of the one or more control variables for a given period of time.

9. The method of claim 1, further comprising:
assigning at least one of the target values corresponding to at least one of the performance metrics based on an analysis of a Directed Acyclic Graph (“DAG”).

10. The method of claim 1, further comprising:
determining second run-time values for the one or more performance metrics of the distributed system; and,
reversing at least one adjustment of a run-time control variable based on at least one of the determined second run-time values for the one or more performance metrics of the distributed system.

11. The method of claim 1, further comprising:
assigning a priority corresponding to at least one of the performance metrics; and,
reversing an adjustment of at least one of the run-time control variables based on the at least one assigned priority.

12. The method of claim 1, wherein at least one of the run-time control variables is adjusted more frequently than at least another one of the run-time control variables.

13. The method of claim 1, wherein comparing the measured run-time values of the performance metrics with one or more target values assigned to the performance metrics further comprises:
determining that at least one of the measured run-time values is outside a target feasibility region.

14. The method of claim 13, further comprising computing a normalized distance between the at least one of the measured run-time values and the target feasibility region.

15. A controller for adjusting a distributed system, the controller comprising:
a processor;
a memory communicatively connected to the processor, the memory storing one or more executable instructions, which, upon execution by the processor, configure the processor for:
determining run-time values for one or more performance metrics of the distributed system;
comparing at least one of the measured run-time values of the performance metrics with one or more target values corresponding to at least one of the performance metrics; and,
adjusting one or more run-time control variables of the distributed system based on the comparison of the determined run-time values with the target values.

16. The controller of claim 1, wherein the processor is further configured for adjusting the one or more run-time control variables by:
increasing or decreasing a number of instances of parallel tasks, processes, or nodes executing in the distributed system.

17. The controller of claim 15, wherein the processor is further configured for determining the run-time values for the one or more performance metrics by:
determining a latency value of a task executing in the distributed system.

18. The controller of claim 15, wherein the processor is further configured for determining the run-time values for the one or more performance metrics by:
determining a throughput value of a process executing in the distributed system.

19. The controller claim 15, wherein the processor is further configured for determining the run-time values for the one or more performance metrics by:
determining one or more utilization values corresponding to one or more resources of the distributed system.

20. The controller of claim 19, wherein the processor is further configured for determining the one or more utilization values by:
determining a change in a size of an inter-task queue between an upstream task and a downstream task executing in the distributed system.

21. The controller of claim 20, wherein the processor is further configured for:
determining a latency value for the upstream task or the downstream task based on the determined change in the size of the inter-task queue.

22. The controller of claim 15, wherein the processor is further configured for:
forbidding adjustment of at least one of the one or more control variables for a given period of time.

23. The controller of claim 15, wherein the processor is further configured for:
assigning at least one of the target values corresponding to at least one of the performance metrics based on an analysis of a Directed Acyclic Graph (“DAG”).

24. The controller of claim 15, wherein the processor is further configured for:
determining second run-time values for the one or more performance metrics of the distributed system; and,
reversing at least one adjustment of a run-time control variable based on at least one of the determined second run-time values for the one or more performance metrics of the distributed system.

25. The controller of claim 15, wherein the processor is further configured for:
assigning a priority corresponding to at least one of the performance metrics; and,
reversing an adjustment of at least one of the run-time control variables based on the at least one assigned priority.

26. The controller of claim 15, wherein at least one of the run-time control variables is adjusted more frequently than at least another one of the run-time control variables.

27. The controller of claim 15, wherein the processor is further configured for comparing the measured run-time values of the performance metrics with one or more target values assigned to the performance metrics by:
determining that at least one of the measured run-time values is outside a target feasibility region.

28. The controller of claim 27, wherein the processor is further configured for computing a normalized distance between the at least one of the measured run-time values and the target feasibility region.
